(19) United States
(12) Patent Application Publication
(10) Pub. No.: US 2025/0306660 A1
(43) Pub. Date: Oct. 2, 2025

(54) POWER EFFICIENCY CALCULATION DEVICE, POWER EFFICIENCY CALCULATION METHOD, POWER EFFICIENCY CALCULATION SYSTEM, AND PROGRAM

(71) Applicant: Nippon Telegraph and Telephone Corporation, Tokyo (JP)

(72) Inventor: Yoshito ITO, Musashino-shi, Tokyo (JP)

(21) Appl. No.: 18/866,012

(22) PCT Filed: May 26, 2022
(86) PCT No.: PCT/JP2022/021619

§ 371 Date: Nov. 14, 2024

(51) Int. Cl. G06F 1/32; G06F 1/28

(52) U.S. Cl. CPC G06F 1/32; G06F 1/28

(57) ABSTRACT

A power efficiency calculation device includes a metrics collection unit that acquires a metrics measurement value including a task execution amount and power consumption from a physical server group; a metrics measurement value complementation determination unit that determines whether or not an amount of change in the metrics measurement values is equal to or greater than a first prescribed value and determines a predetermined complementation scheme; a power efficiency calculation frame complementation determination unit that determines whether or not a value of a deviation between a time frame of power efficiency calculation and a metrics acquisition interval is equal to or greater than a second prescribed value, and determines a predetermined complementation scheme; a metrics complementation unit that performs complementation by using the predetermined complementation scheme determined; and a power efficiency calculation unit that calculates an integral value in a time frame of power efficiency calculation and calculates power efficiency.

### TECHNICAL FIELD

The present invention relates to a power efficiency calculation device, a power efficiency calculation method, a power efficiency calculation system, and a program, for calculating power efficiency for application processing.

### BACKGROUND ART

Various definitions have been proposed for a power efficiency index of a data center. Among them, the only index which can be measured and calculated in real time as to with what degree of power efficiency a specific application can be operated is Data Center energy Productivity (DCeP) (refer to NPL 1). The DCeP is defined in Equation (1) below.

$$\begin{matrix}[ Math . 1 ] & \\ DCeP = \frac{Useful Work Produced}{Total Energy Consumed to Perform that Work} & Equation ( 1 )\end{matrix}$$

DCeP (power efficiency) is defined as “Useful Work Produced” (herein referred to as “work output”) divided by “Total Energy Consumed to Perform That Work” (herein referred to as “power consumption”).

In addition, the “useful work produced” (work output) is defined by Equation (2) below.

$$\begin{matrix}[ Math . 2 ] & \\ Usefule Work Produced = {\sum }_{i = 1}^{M} {V}_{i} * {U}_{i} ( t , T ) * {T}_{i} & Equation ( 2 )\end{matrix}$$

Here, “M” denotes the number of tasks started in an assessment window, “Vᵢ” denotes a normalization coefficient obtained by summing up numerical values of the tasks, “Uᵢ (t, T)” denotes a time-based utility function of each task, “t” denotes an elapsed time from start to completion of the task, and “T” denotes an absolute time at task completion.

Further, NPL 2 describes a result of calculating DCeP with “Useful Work Produced” (work output) is defined as energy consumed when various applications are performed in a high performance computing (HPC) data center. However, NPL 2 does not describe the power calculation (power consumption) in detail, but reports only a calculation result.

Further, NPL 3 defines the “Useful Work Produced” (work output) as the number of times two kinds of applications are executed (useful computational units) within a certain time, and the number of times each application is executed with a weight coefficient (1:0.08) is normalized. However, NPL 3 does not describe the power calculation (power consumption) in detail, but only a calculation result is reported.

It is assumed that the actual measurement value of the “Total Energy Consumed to Perform that Work” (power consumption) is acquired by are acquiring metrics that are an assessment index of performance or the like from a system (a “physical server group 30” described below) by using metrics collection software (resource monitoring software). Prometheus, which is one de facto standard of the metrics collection software, is able to acquire power [W] by using an Intelligent Platform Management Interface (IPMI) exporter. However, because this power (power consumption) is an instantaneous value, it is necessary to calculate an integral value in order to obtain the power consumption [Wh or J]. Further, it is assumed that the “Useful Work Produced” (work result amount) is required to be calculated similarly by using metrics whose integral value is required to be calculated.

### CITATION LIST

### Non Patent Literature

[NPL 1] D. Anderson, et al., “A framework for data center energy productivity”, The Green Grid, 2008. [NPL 2] A. Grishina, et al., “DC energy data measurement and analysis for productivity and waste energy assessment”, 2018 IEEE International Conference on Computational Science and Engineering (CSE), IEEE, 2018.
[NPL 3] Landon H. Sego, et al., “Implementing the data center energy productivity metric”, ACM Journal on Emerging Technologies in Computing Systems (JETC) 8.4 (2012): 1-22.
[NPL 4] “prometheus-community/ipmi exporter,” GitHub, Inc., [online], [Retrieved on May 9, 2022], Internet <URL: https://github. com/prometheus-community/ipmi exporter/blob/master/docs/metrics.md #power-consumption>

### SUMMARY OF INVENTION

### Technical Problem

If the following two points are not appropriately handled at the time of calculating an integral value such as power consumption, a large deviation occurs between an actual value and a calculation result:
(1) complementation between the metrics measurement values,
(2) correction (complementation) of a deviation between the time frame (assessment window) for power efficiency calculation and the metrics acquisition interval.

The above two points are always required in a metrics collection tool such as Prometheus.

FIG. 7 is a diagram illustrating data of metrics (power [W] or the number of access) collected from a system (referred to as a “physical server group 30” described below) in time series (abscissa: Time [S]).

In the example illustrated in FIG. 7, a period of calculating an amount of power (power consumption) is that of the assessment window which is a period of calculating DCeP (power efficiency). However, the metrics collection tool holds only data in a section of a hatched portion, and before and after portions (indicated by reference signs P₁ and P₂) shown by hatching cannot be calculated. Therefore, it is necessary to compensate a deviation between a time frame of the power efficiency calculation (assessment window) and the metrics acquisition interval.

Further, it is necessary to determine to adopt a linear complementation as illustrated in FIG. 7 or another complementation on the data of the hatched portion (power of an instantaneous value indicated by circle marks), that is, data between the metrics measurement values.

Thus, unless performing (1) the complementation between the metrics measurement values and (2) the correction (complementation) of the deviation between the time frame (assessment window) for power efficiency calculation and the metrics acquisition interval, it is not possible to accurately calculate an integral value such as power consumption. Further, because the power consumption cannot be accurately calculated, it is not possible to accurately calculate the DCeP (power efficiency) whose calculation needs to use the power consumption.

The present invention has been made in view of such problems and an object thereof is to calculate accurate power efficiency by using a complemented integral values.

### Solution to Problem

device The present invention provides a power efficiency calculation device for calculating power efficiency by executing an application installed on a physical server group, the power efficiency calculation device including a metrics collection unit configured to acquire a metrics measurement value from the physical server group, the metrics measurement value being an assessment index necessary for power efficiency calculation and including a task execution amount of the application and power consumption of the physical server group; a metrics measurement value complementation determination unit configured to determine whether or not complementation between the metrics measurement values is required according to whether or not an amount of change in the metrics measurement value is equal to or more than a first prescribed value and to determine a predetermined complementation scheme according to whether or not the complementation is required; a power efficiency calculation frame complementation determination unit configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and to determine a predetermined complementation scheme according to whether or not the complementation is required; a metrics complementation unit configured to perform the complementation between the metrics measurement values by using the predetermined complementation scheme determined by the metrics measurement value complementation determination unit, and to perform complementation of the deviation between the time frame of power efficiency calculation and the metrics acquisition interval by using the predetermined complementation scheme determined by the power efficiency calculation frame complementation determination unit; and a power efficiency calculation unit configured to calculate an integral value in the time frame of the power efficiency calculation with respect to the task execution amount and the power consumption of the physical server group that are the metrics measurement values complemented by the metrics complementation unit and to calculate power efficiency.

### Advantageous Effects of Invention

According to the present invention, it is possible to calculate accurate power efficiency using the complemented integral value.

### BRIEF DESCRIPTION OF DRAWINGS

FIG. 1 is a diagram illustrating an overall configuration of a power efficiency calculation system including a power efficiency calculation device according to a present embodiment.

FIG. 2 is a diagram for describing an error “a” related to a first prescribed value according to the present embodiment.

FIG. 3 is a flowchart illustrating a flow of processing executed by the power efficiency calculation device according to the present embodiment.

FIG. 4 is a diagram illustrating an example in which a data transfer amount of user plane function (UPF) is collected as a metrics measurement value.

FIG. 5 is a diagram illustrating an example in which power is collected as a metrics measurement value.

FIG. 6 is a hardware configuration diagram illustrating an example of a computer that implements functions of the power efficiency calculation device according to the present embodiment.

FIG. 7 is a diagram illustrating data of a metrics measurement value (power or number of accesses) collected from the system in time series.

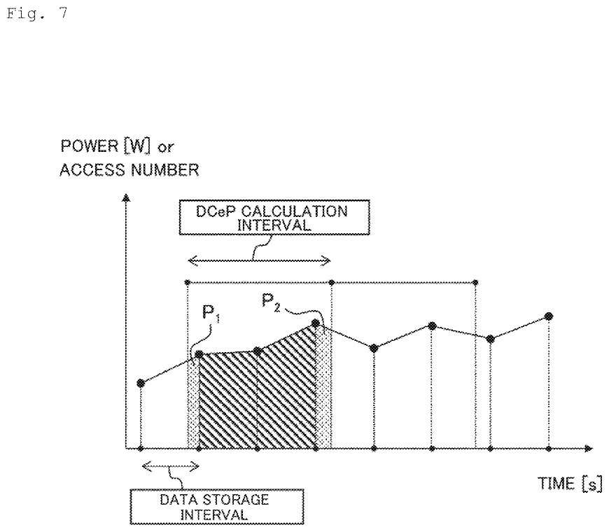

### DESCRIPTION OF EMBODIMENTS

Next, an embodiment for carrying out the present invention (hereinafter referred to as “the embodiment”) is described.

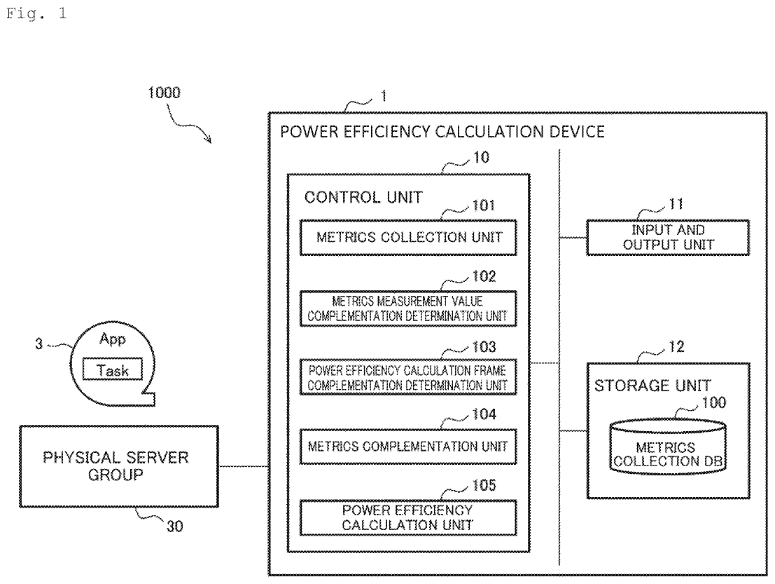

FIG. 1 is a diagram illustrating an overall configuration of a power efficiency calculation system 1000 including a power efficiency calculation device 1 according to the embodiment.

The power efficiency calculation system 1000 includes, for example, the physical server group 30 configured of a data center or the like, and the power efficiency calculation device 1 communicatively connected to the physical server group 30.

The physical server group 30 is operated, for example, with a virtualization infrastructure constructed on physical servers, and one or more applications 3 are installed on a virtual machine (VM) or a container on a virtual OS to execute processing. Each application 3 provides a service by executing one or more tasks.

The power efficiency calculation device 1 collects metrics such as “task execution amount and power consumption” described below, which are assessment indexes required for calculation of DCeP (power efficiency) from the physical server group 30, determines whether or not the complementation between the metrics measurement values is required and whether or not correction (complementation) of a deviation between a time frame of power efficiency calculation and a metrics acquisition interval is required, and determines a complementation scheme for each case. The power efficiency calculation device 1 performs necessary complementation and then calculates DCeP (power efficiency).

Thus, the power efficiency calculation device 1 can determine whether or not the complementation between the metrics measurement values and correction (complementation) of the deviation between a time frame of power efficiency calculation and a metrics acquisition interval are required, and then calculate the integral value from the data of the complemented metrics measurement value to calculate accurate power efficiency. Here, the power efficiency calculation device 1 can determine whether or not the complementation processing is required, thereby reducing an overhead due to unnecessary calculation by not performing the calculation of the linear complementation or polynomial complementation described below when a determination is made that the complementation is not required.

Further, the power efficiency calculation device 1 can re-adjust the complementation processing predetermined time intervals, thereby determining whether or not the complementation processing is required according to an amount of temporal change of the metrics measurement value, and executing the calculation of DCeP (power efficiency).

Next, the power efficiency calculation device 1 is described in detail.

As illustrated in FIG. 1, the power efficiency calculation device 1 includes a control unit 10, an input and output unit 11, and a storage unit 12.

The input and output unit 11 inputs or outputs information to or from, for example, each server in the physical server group 30. The input and output unit 11 includes a communication interface for performing information transmission or reception via a communication line, and an input and output interface for performing information of input from an input device such as a keyboard and output to an output device such as a monitor (not illustrated).

The storage unit 12 includes a hard disk, a flash memory, a random access memory (RAM), and the like.

The storage unit 12 temporarily stores a program for causing functions of the control unit 10 to be executed or information that is necessary for processing of the control unit 10. Further, the storage unit 12 stores metrics necessary for calculation of DCeP (power efficiency) that are collected from each physical server in the physical server group 30, a virtual OS (OS), a VM, a container, an application, or the like in a metrics collection database (DB) 100.

The control unit 10 controls the entire processing executed by the power efficiency calculation device 1, and includes a metrics collection unit 101, a metrics measurement value complementation determination unit 102, a power efficiency calculation frame complementation determination unit 103, a metrics complementation unit 104, and a power efficiency calculation unit 105, as illustrated in FIG. 1.

The metrics collection unit 101 acquires metrics (assessment indexes such as performance) necessary for power efficiency calculation from the physical server group 30, and stores the metrics in the metrics collection DB 100.

The metrics collection unit 101 collects metrics from a physical server, an OS (virtual OS), a VM/container, an application, or the like included in the physical server group 30 by using existing metrics collection software (for example, Prometheus).

For example, the metrics collection unit 101 collects, from the physical server group 30, information on a task execution amount (the number of times the request is processed by an application, a data transfer amount, or the like), and power consumption [W] as a metrics measurement value and stores the information in the metrics collection DB 100.

The metrics collection unit 101 collects the metrics from the physical server group 30 in advance before calculating the DCeP (power efficiency) which is described below as a “preliminary preparation stage” described below. Further, the metrics collection unit 101 also collects metrics when calculating the DCeP (power efficiency), which is described below as an “operation stage”, or when re-adjusting the complementation scheme, which is described below as a re-adjustment stage.

Further, the metrics collection unit acquires a value (power) obtained by measuring the power consumption of the entire physical server group 30 from a wattmeter (not illustrated) included in the physical server group 30 in the preliminary preparation stage and the re-adjustment stage.

The metrics measurement value complementation determination unit 102 determines whether or not the complementation between the metrics measurement values in response to change in the metrics measurement value (discrete values) collected by the metrics collection unit 101, and determines a complementation scheme (linear complementation, polynomial complementation, or the like) when a determination is made that complementation is to be performed.

The metrics measurement value complementation determination unit 102 determines that change is small, a deviation of the integral value is small, and the complementation is not needed to be performed when the change in the discrete value is smaller than a prescribed value (first prescribed value) regarding the complementation between the metrics measurement values. On the other hand, when the change in the discrete value is equal to or greater than the first prescribed value, the metrics measurement value complementation determination unit 102 determines that the deviation of the integral value becomes larger and the complementation is to be performed. The first prescribed value is re-adjusted through comparison thereof with a measurement value of the wattmeter for each predetermined period. Thereby, the deviation of the integral value is kept equal to or below a fixed rate, whose detail is described below.

Specifically, the metrics measurement value complementation determination unit 102 acquires the metrics measurement value for a predetermined period from the metrics collection DB 100. The metrics measurement value complementation determination unit 102 obtains a magnitude D of the time difference between the metrics measurement values shown in Equation (3) below. Here, xᵢ denotes an i-th metrics measurement value (discrete value). N is the number of measurement timings (the number of times measurement is performed) in the predetermined period.

$$\begin{matrix}[ Math . 3 ] & \\ D = {{\sum }^{N - 1}}_{i = 0} \sqrt{{( {x}_{i} - {x}_{i + 1} )}^{2}} & Equation ( 3 )\end{matrix}$$

The metrics measurement value complementation determination unit 102 may use Equation (4) below instead of Equation (3). In Equation (3), it is possible to assess a future error occurrence frequency involved in load fluctuation without omission by using a square root. On the other hand, when each term can take as shown in Equation (4), an offset between an upward swing and a lower swing of the error can be taken into consideration. In the metrics measurement value complementation determination unit 102, which of Equations (3) and (4) to be used is set in advance.

$$\begin{matrix}[ Math . 4 ] & \\ D = {\sum }_{i = 0}^{N - 1} ( {x}_{i} - {x}_{i + 1} ) & Equation ( 4 )\end{matrix}$$

When the magnitude D of the time difference is equal to or greater than the first prescribed value shown in Equation (5) below, the metrics measurement value complementation determination unit 102 determines that complementation is to be executed.

The metrics measurement value complementation determination unit 102 determines, for example, the linear complementation or polynomial complementation as a complementation scheme.

The linear complementation is a scheme for linearly connecting a value at a certain point in time and a value at a next point in time and complementing therebetween for the metrics measurement values. The polynomial complementation is a scheme for performing polynomial approximation using a plurality of past values of the metrics measurement values to complement therebetween.

The metrics measurement value complementation determination unit 102 may be preset to adopt either the linear complementation or polynomial complementation as to the complementation scheme when a determination is made that the complementation is to be executed, or may provide a threshold value according to a magnitude D of a time difference, and determine complementation scheme using a logic in which the polynomial complementation is adopted when a value is equal to or greater than the predetermined threshold value, and the linear complementation is adopted when the value is smaller than the predetermined threshold value.

Further, the metrics measurement value complementation determination unit 102 determines that complementation is not executed when the magnitude D of the time difference is smaller than the first prescribed value shown in Equation (5) below.

When a determination is made that the complementation is not executed, the metrics measurement value complementation determination unit 102 regards a metrics value as a constant value without change from a metrics measurement value at a previous point in time and performs complementation with the constant value until a measurement timing at the next point in time (constant value complementation).

That is, the metrics measurement value complementation determination unit 102 determines whether or not the complementation between the metrics measurement values is required, and then determines predetermined complementation scheme (linear complementation, polynomial complementation, constant value complementation, or the like).

When the magnitude D of the time difference is equal to or greater than the first prescribed value represented by the Equation (5) below, the metrics measurement value complementation determination unit 102 determines that the complementation (the linear complementation or polynomial complementation or the like) is to be executed. Here, “a” is a value of the error set to satisfy a preset allowable error rate, and details are described below.

$$\begin{matrix}[ Math . 5 ] & \\ D \geq 2 α {\sum }_{i = 0}^{N - 1} {x}_{i} , ( 0 < α \leq 1 ) & Equation ( 5 )\end{matrix}$$

When the magnitude D of the time difference is equal to or greater than the first prescribed value, the metrics measurement value complementation determination unit 102 may instruct the metrics collection unit 101 to narrow down the metrics measurement interval. Thus, the magnitude of the deviation between the metrics measurement values can be reduced.

<Determination Scheme of Error “a” Related to First Prescribed Value>

Here, the error “a” related to the first prescribed value is described.

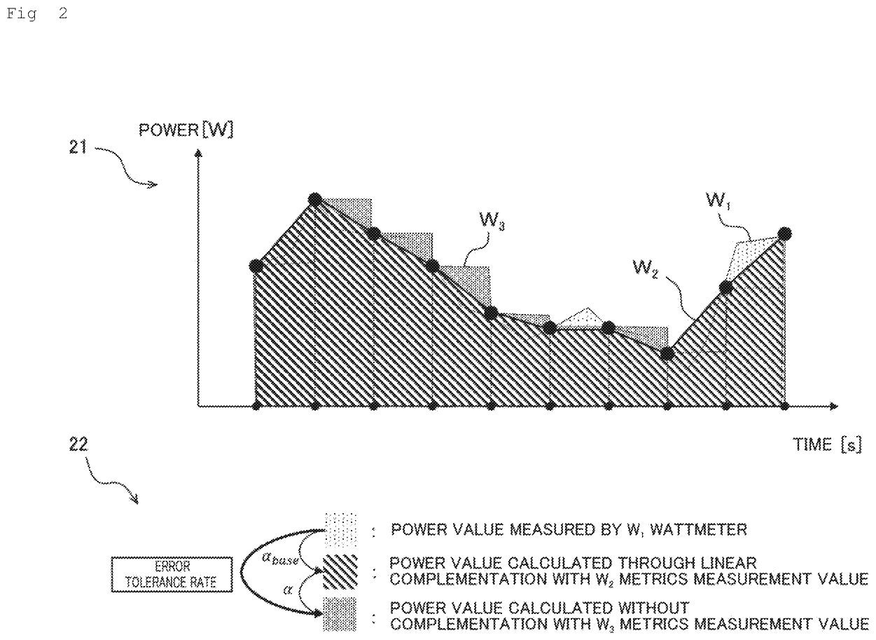

FIG. 2 is a diagram for describing the error “x” related to the first prescribed value.

Reference sign 21 in FIG. 2 denotes a diagram illustrating a power value of the physical server group 30 that is a calculation target for DCeP (power efficiency) in time series. Here, a power value indicated by W₁ is a value obtained by measuring the power value of the physical server group 30 using the wattmeter. A power value indicated by W₂ indicates a value obtained by calculating the complementation between the metrics measurement values with the linear complementation or polynomial complementation on the basis of the metrics measurement value of the power. In the following description, it is assumed that the linear complementation is employed and the calculation is performed. A power value indicated by W₃ indicates a value calculated without complementing the metrics measurement value, that is, calculated with the constant value complementation.

Here, a value Pₗᵢₙₑₐᵣ calculated by the linear complementation with the metrics measurement value of the power is compared with a value Pₘₑₐₛᵤᵣₑ acquired from the wattmeter, and an error α_{base}=|1−Pₗᵢₙₑₐᵣ/Pₘₑₐₛᵤᵣₑ| is calculated. An error tolerance rate for determining whether or not complementation is required is determined, and the error “a” is defined as shown in Equation (6) below.

$$\begin{matrix}[ Math 6 ] & \\ α = error tolerance - {α}_{base} & Equation ( 6 )\end{matrix}$$

As indicated by reference sign 22 in FIG. 2, an error α_{base} based on the value of the wattmeter and a value obtained by performing linear complementation or polynomial complementation on power as a metrics measurement value is calculated, and the error “α” is determined as a value decreasing as a difference between the calculated error α_{base} and a preset error tolerance rate is smaller. The error “α” is used to set the first prescribed value (see Equation (5)). In Equation (6), a ratio of a complementation calculation target portion (a sum of triangles added in the case of the linear complementation to an integral value of the constant value complementation calculated without complementing the metrics measurement value is calculated, and the error “α” is determined.

Referring back to FIG. 1, the power efficiency calculation frame complementation determination unit 103 determines whether or not the correction (complementation) of the deviation between the time frame (assessment window) of power efficiency calculation and the metrics acquisition interval is performed, and determines a complementation scheme (linear complementation, polynomial complementation or the like) when a determination is made that complementation is performed.

The power efficiency calculation frame complementation determination unit 103 determines whether or not a deviation due to the start and the end should be complemented when a start time and an end time of the time frame (assessment window) of the power efficiency calculation do not match the metrics acquisition timing. When the value of the deviation is smaller than a prescribed value (a second prescribed value to be described below), the power efficiency calculation frame complementation determination unit 103 determines that the complementation is not performed (the constant value complementation) since a load (resource consumption) by the complementation calculation processing becomes large.

The power efficiency calculation frame complementation determination unit 103 calculates a maximum value of time deviation between the time frame (assessment window) of the power efficiency calculation and the metrics acquisition timing on the basis of time granularity (for example, one second) regarding calculation of DCeP (power efficiency). The maximum value of the time deviation is a sum value of the deviation on the start side and the deviation on the end side.

The power efficiency calculation frame complementation determination unit 103 determines whether or not the time deviation is equal to or greater than a preset prescribed value (the second prescribed value). The second prescribed value may be set as n % of the time frame (assessment window) of the power efficiency calculation, or may be set as a fixed value such as m seconds.

It is assumed that the second prescribed value is set in advance in the power efficiency calculation frame complementation determination unit 103.

The power efficiency calculation frame complementation determination unit 103 determines that complementation is to be executed when the maximum value of the time deviation is equal to or greater than the second prescribed value. The power efficiency calculation frame complementation determination unit 103 determines, for example, the linear complementation or polynomial complementation as the complementation scheme.

The power efficiency calculation frame complementation determination unit 103 sets in advance that the linear complementation or the polynomial complementation is adopted as a complementation scheme when a determination is made that the complementation is to be executed.

The power efficiency calculation frame complementation determination unit 103 determines that the complementation is not to be executed when the maximum value of the time deviation is smaller than the second prescribed value. When a determination is made that the complementation is not to be executed, the power efficiency calculation frame complementation determination unit 103 regards the value as the metrics measurement value (measurement values of the start and end of the metrics measurement) and as being constant during the time deviation and performs the complementation (the constant value complementation).

That is, the power efficiency calculation frame complementation determination unit 103 determines whether or not the correction (complementation) of the deviation between the time frame (assessment window) of the power efficiency calculation and the metrics acquisition interval is required, and then determines the predetermined complementation scheme (linear complementation, polynomial complementation, constant value complementation, or the like).

The metrics complementation unit 104 performs the complementation between the metrics measurement values on the metrics collected by the metrics collection unit 101 by using the complementation scheme (the linear complementation, the polynomial complementation, the constant value complementation, or the like) determined by the metrics measurement value complementation determination unit 102. Further, the metrics complementation unit 104 performs the correction (complementation) of the deviation between the time frame (assessment window) of power efficiency calculation and the metrics acquisition interval by using the complementation scheme (the linear complementation, the polynomial complementation, the constant value complementation, or the like) determined by the power efficiency calculation frame complementation determination unit 103.

The power efficiency calculation unit 105 calculates an integral value by using a value obtained by complementing “Useful Work produced” (work result amount) and “Total Energy Consumed to Perform that Work” (power consumption) shown in Equation (1) above. The power efficiency calculation unit 105 calculates the power efficiency by dividing the calculated “Useful Work produced” (work result amount) by the calculated “Total Energy Consumed to Perform that Work” (power consumption).

As a modification example of the configuration illustrated in FIG. 1, the power efficiency calculation device 1 does not include the power efficiency calculation frame complementation determination unit 103 in the control unit 10, and may perform only the complementation between the metrics measurement values by the metrics measurement value complementation determination unit 102. Further, the power efficiency calculation device 1 does not include the metrics measurement value complementation determination unit 102 in the control unit 10, and may perform only the correction (complement) of the deviation between the time frame of the power efficiency calculation and the metrics acquisition interval using the power efficiency calculation frame complementation determination unit 103.

### <Processing of Power Efficiency Calculation Device>

Next, a flow of processing executed by the power efficiency calculation device 1 is described.

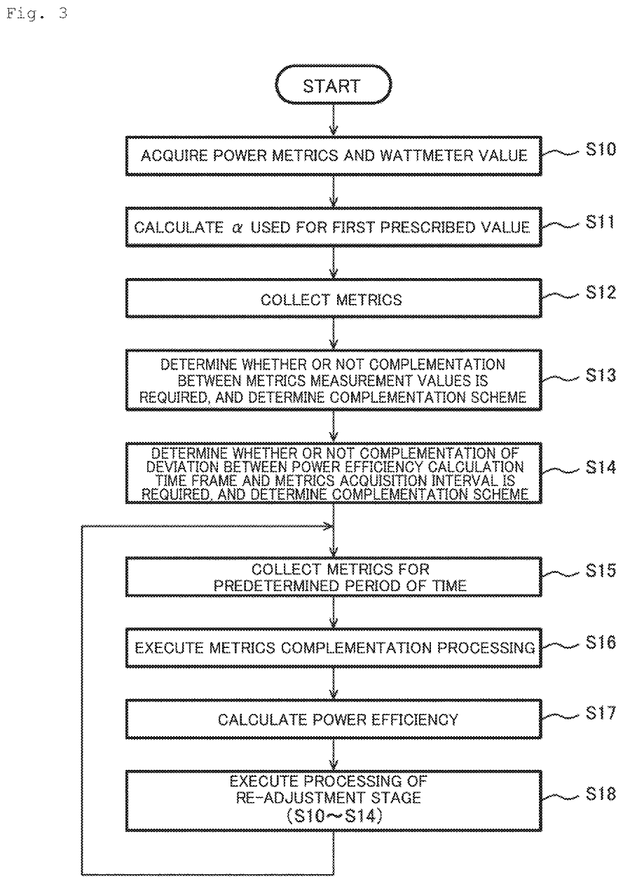

FIG. 3 is a flowchart illustrating a flow of processing executed by the power efficiency calculation device 1 according to the present embodiment.

The processing executed by the power efficiency calculation device 1 includes a preliminary preparation stage, an operation stage, and a re-adjustment stage.

In the preliminary preparation stage, the power efficiency calculation device 1 sets the first prescribed value using the metrics collected in advance from the physical server group 30 and a value acquired from the wattmeter, determines whether or not the complementation between the metrics measurement values is required, and determines the complementation scheme. Further, the power efficiency calculation device 1 determines whether or not the correction (complementation) of the deviation between the time frame (assessment window) of power efficiency calculation and the metrics acquisition interval is required, and determines a complementation scheme thereof.

Further, in the operation stage, the power efficiency calculation device 1 performs the complementation between the metrics measurement values and the correction (complementation) of the deviation between the time frame (assessment window) of the power efficiency calculation and the metrics acquisition interval by using the complementation scheme determined in the preliminary preparation stage, and then calculates the integral value to calculate DCeP (power efficiency).

In the re-adjustment stage, the power efficiency calculation device 1 updates the first prescribed value by using the metrics acquired at that time and the value of the wattmeter. It is determined again whether or not the complementation between the metrics measurement values is required and whether or not the correction (complementation) of the deviation between the time frame (assessment window) of power efficiency calculation and the metrics acquisition interval is required, and determines the complementation scheme. The power efficiency calculation device 1 returns to the operation stage and repeats processing for calculating DCeP (power efficiency).

It is assumed that the second prescribed value is set in advance in the power efficiency calculation frame complementation determination unit 103.

Further, description is given using an example in which DCeP (power efficiency) is monitored in an operating environment of a UPF application for packet transfer of user data from a user terminal to a data network (the Internet or the like) as an example of application.)

First, as the preliminary preparation stage, the metrics collection unit 101 of the power efficiency calculation device 1 acquires the power metrics and the value of the wattmeter from the physical server group 30 (step S10).

Next, the metrics measurement value complementation determination unit 102 extracts the metrics of the power in a predetermined period (a period longer than the assessment window) and the value of the wattmeter during the period, and calculates an error “x” to be used for the first prescribed value regarding the complementation between the metrics measurement values (step S11).

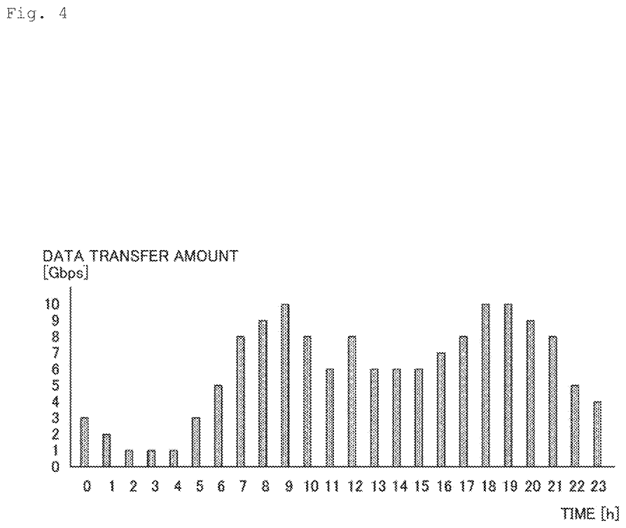

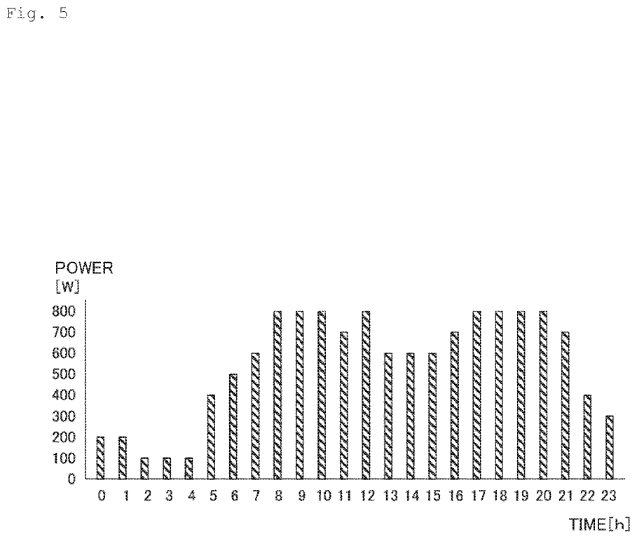

Subsequently, the metrics collection unit 101 acquires metrics (for example, a data transfer amount as a task execution amount, and power consumption [W]) required for power efficiency calculation from the physical server group 30, and stores the metrics in the metrics collection DB 100 (step S12). Further, the collection of metrics in step S12 necessary for the power efficiency calculation is continuously performed every predetermined period (assessment window). Here, for example, it is assumed that an interval of metrics measurements is set every 60 minutes and metrics are collected for 24 hours. FIG. 4 illustrates an example in which the data transfer amount [Gbps] of UPF is collected as the metrics measurement value, and FIG. 5 illustrates an example in which power is collected.

The metrics measurement value complementation determination unit 102 determines whether or not complementation is to be performed on the metrics measurement values for each acquired metrics (data transfer amount, and power consumption [W]), and the complementation scheme is determined (step S13).

More specifically, the metrics measurement value complementation determination unit 102 obtains the magnitude D of the time difference shown in Equation (3) or Equation (4) above for each metrics measurement value, and compares the magnitude D with the first prescribed value (see Equation (5)) calculated by using the error “x” calculated in step S11. When the magnitude D of the time difference is equal to or greater than the first prescribed value, a determination is made that the complementation is to be executed, and the complementation scheme is determined from among the linear complementation, polynomial complementation, or the like (here, the linear complementation is determined). On the other hand, when the magnitude D of the time difference is smaller than the first prescribed value, it is determined that the complementation is not to be executed, and the complementation scheme is determined to be the constant value complementation.

Here, it is assumed that, for example, as the first prescribed value of the data transfer amount (metrics measurement amount), 28.8 [Gbps] is calculated from the data illustrated in FIG. 4 and the error α, and 2640 [W] is calculated from the data illustrated in FIG. 5 and the error α as the first prescribed value of the power (metrics measurement amount), and is compared with the magnitude D of the time difference.

When the magnitude D of the time difference is calculated as, for example, 33 [Gbps] from the data transfer amount illustrated in FIG. 4, it results in 33>28.8, that is, the magnitude D of the time difference is equal to or greater than the first prescribed value. Therefore, a determination is made that the complementation is to be executed, and the complementation scheme is determined to be the linear complementation. On the other hand, when the magnitude D of the time difference is calculated as 2200 [W] from the power illustrated in FIG. 5, it results in 2200<2460, that is, the magnitude D of the time difference is smaller than the first prescribed value. Therefore, a determination is made that the complementation is not to be executed, and the complementation scheme is determined to be the constant value complementation.

Next, the power efficiency calculation frame complementation determination unit 103 determines whether or not complementation is performed on a deviation between the time frame (assessment window) of the power efficiency calculation and the metrics acquisition interval, and determines the complementation scheme (step S14).

Specifically, the power efficiency calculation frame complementation determination unit 103 calculates the maximum value of the time deviation between the time frame (assessment window) of the power efficiency calculation and the metrics acquisition timing on the basis of time granularity (for example, one minute) regarding calculation of DCeP (power efficiency). Assuming that the metrics measurement interval is 60 minutes, the deviation (maximum value) on the start side is 59 minutes and the deviation (maximum value) on the end side is 59 minutes, and thus, the maximum value of the time deviation is 59+59=118 minutes.

Here, assuming that the second prescribed value is up to 10% of the time frame (assessment window) of the power efficiency calculation, when the time frame (assessment window) of the power efficiency calculation is 360 minutes, the second prescribed value is 360×0.1=36. Therefore, because the maximum value (118 minutes) of the time deviation is equal to or greater than the second prescribed value (36 minutes), the power efficiency calculation frame complementation determination unit 103 determines that complementation is to be executed, and determines as the complementation scheme one of the linear complementation, polynomial complementation, or the like (in this case, the linear complementation).

Here, the power efficiency calculation frame complementation determination unit 103 may perform setting to shorten the metrics measurement interval when the maximum value of the time deviation is equal to or greater than the second prescribed value. For example, the metrics measurement interval is changed from 60 minutes to 30 minutes. This makes it possible to reduce the maximum value of the time deviation.

The processing of steps S10 to S14 is performed in the preliminary preparation stage.

Next, processing in the operation stage is described.

In the operation stage, the processing of the following steps S15 to S17 is repeatedly executed for every assessment window (for example, 360 minutes).

First, the metrics collection unit 101 of the power efficiency calculation device 1 collects metrics (task execution amount (data transfer amount) and power) in a predetermined period (step S15).

Subsequently, the metrics complementation unit 104 of the power efficiency calculation device 1 executes metrics complementation processing (step S16).

Specifically, in step S16, the metrics complementation unit 104 executes the complementation processing between the metrics measurement values by using a complementation scheme (the linear complementation, the polynomial complementation, the constant value complementation, and the like) determined in step S13 by metrics measurement value complementation determination unit 102. In the example of step S13, the linear complementation is determined for the data transfer amount and the constant value complementation is determined for the power as a complementation scheme, and thus the metrics complementation unit 104, in the example of step S14, executes the complementation between the metrics measurement values by using the linear complementation determined in the example of step S13.

In step S14, the metrics complementation unit 104 executes processing for complementing the deviation between the time frame (assessment window) of the power efficiency calculation and the metrics acquisition interval by using the complementation scheme (the linear complementation, the polynomial complementation, the constant value complementation, and the like) determined by the power efficiency calculation frame complementation determination unit 103. The metrics complementation unit 104 complements the deviation between the time frame (assessment window) of the power efficiency calculation and the metrics acquisition interval through the linear complementation because the linear complementation is determined as the complementation scheme in the example of step S14.

The power efficiency calculation unit 105 calculates the integral value by using the value obtained by complementing “Useful Work produced” (work result amount) and “Total Energy Consumed to Perform that Work” (power consumption) shown in Equation (1) above. Specifically, the power efficiency calculation unit 105 calculates the integral value by using the complemented data for the task execution amount and the metrics measurement value of the power. The power efficiency calculation unit 105 calculates the power efficiency by dividing the calculated “Useful Work produced” (work result amount) by the calculated “Total Energy Consumed to Perform that Work” (power consumption) (step S17).

The processing up to this point is the processing in the operation stage.

Subsequently, the power efficiency calculation device 1 executes processing of the re-adjustment stage in a predetermined time interval (step S18). The processing of the re-adjustment stage is the same as the processing of steps S10 to S14 in the preliminary preparation stage. The power efficiency calculation device 1 executes, in the re-adjustment stage, the complementation processing in the predetermined time interval, thereby, to determine whether or not the complementation between the metrics measurement values is required, and whether or not the correction (complementation) of the deviation between the time frame (assessment window) of power efficiency calculation and the metrics acquisition interval is required, and determines the complementation scheme. By providing this re-adjustment stage, the optimum complementation processing corresponding to the time change of the metrics measurement value can be executed. The power efficiency calculation device 1 returns to the operation stage from step S15, and repeats processing for calculating DCeP (power efficiency).

Thus, the power efficiency calculation device 1 can determine whether or not the complementation between the metrics measurement values and the correction (complement) of the deviation between the time frame of the power efficiency calculation and the metrics acquisition interval are required, calculate an integral value on the basis of the complemented data, and calculate accurate power efficiency.

Further, the power efficiency calculation device 1 re-adjusts the complementation processing in a predetermined time interval, thereby determining whether or not the complementation processing is required according to the amount of temporal change of the metrics value and executing the calculation of DCeP (power efficiency).

### <Hardware Configuration>

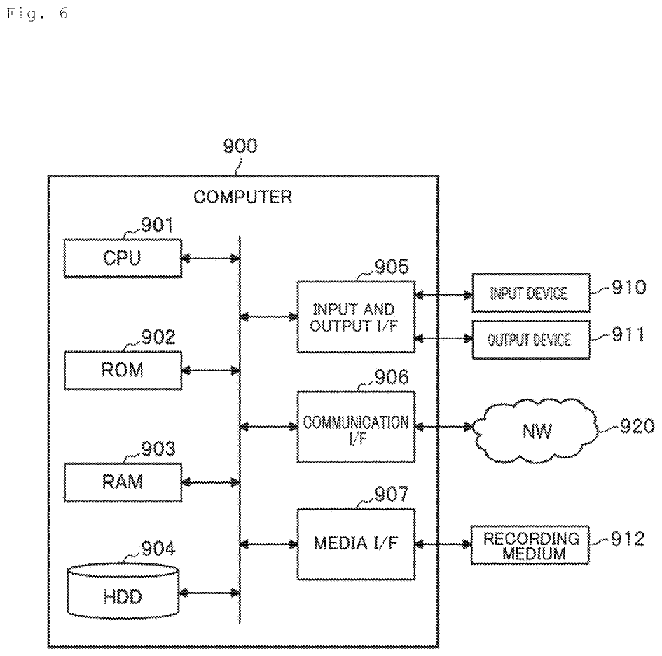

The power efficiency calculation device 1 according to the present embodiment is constructed by, for example, a computer 900 having a configuration as illustrated in FIG. 6.

FIG. 6 is a hardware configuration diagram illustrating an example of the computer 900 that achieves the function of the power efficiency calculation device 1 according to the present embodiment. The computer 900 includes a central processing unit (CPU) 901, a read only memory (ROM) 902, a RAM 903, a hard disk drive (HDD) 904, an input and output interface (I/F) 905, a communication I/F 906, and a medium I/F 907.

The CPU 901 operates on the basis of a program stored in the ROM 902 or the HDD 904 and performs control by the control unit 10 (FIG. 1). The ROM 902 stores a boot program executed by the CPU 901 when the computer 900 is started, a program related to hardware of the computer 900, and the like.

The CPU 901 controls an input device 910 such as a mouse or a keyboard, and an output device 911 such as a display or a printer through the input and output I/F 905. The CPU 901 acquires data from the input device 910 through the input and output I/F 905, and outputs generated data to the output device 911.

The HDD 904 stores a program executed by the CPU 901, data used by the program, and the like. The communication I/F 906 receives data from another device through a communication network (for example, a NW (Network) 920), outputs the data to the CPU 901, and transmits data generated by the CPU 901 to other devices through the communication network.

The medium I/F 907 reads a program or data stored in a recording medium 912 and outputs the program or data to the CPU 901 through the RAM 903. The CPU 901 loads a program related to desired processing from the recording medium 912 onto the RAM 903 through the medium I/F 907, and executes the loaded program. The recording medium 912 is an optical recording medium such as a digital versatile disc (DVD) or a phase change rewritable disk (PD), a magnetooptic recording medium such as a magneto optical disk (MO), a magnetic recording medium, a semiconductor memory, or the like.

For example, when the computer 900 serves as the power efficiency calculation device 1 according to the present embodiment, the CPU 901 of the computer 900 implements the function of the power efficiency calculation device 1 by executing a program loaded onto the RAM 903. Further, data in the RAM 903 is stored in the HDD 904. The CPU 901 reads the program related to the desired processing from the recording medium 912 and executes the program. In addition, the CPU 901 may read the program related to the desired processing from another device through a communication network (NW 920).

### Effects

Hereinafter, effects of the power efficiency calculation device 1 and the like according to the present invention is described.

A power efficiency calculation device 1 according to the present invention is a power efficiency calculation device 1 for calculating power efficiency by executing an application 3 installed on a physical server group 30, wherein the power efficiency calculation device 1 includes a metrics collection unit 101 configured to collect a metrics measurement value from the physical server group 30, the metrics measurement value being an assessment index necessary for power efficiency calculation and including a task execution amount of the application 3 and power consumption of the physical server group 30; a metrics measurement value complementation determination unit 102 configured to determine whether or not complementation between the metrics measurement values is required according to whether or not an amount of change in the metrics measurement value is equal to or more than a first prescribed value, and determine a predetermined complementation scheme according to whether or not the complementation is required; a power efficiency calculation frame complementation determination unit 103 configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and determine a predetermined complementation scheme according to whether or not the complementation is required; a metrics complementation unit 104 configured to perform the complementation between the metrics measurement values by using the predetermined complementation scheme determined by the metrics measurement value complementation determination unit 102, and perform complementation of the deviation between the time frame of power efficiency calculation and the metrics acquisition interval by using the predetermined complementation scheme determined by the power efficiency calculation frame complementation determination unit 103; and a power efficiency calculation unit 105 configured to calculate an integral value in the time frame of the power efficiency calculation and calculate power efficiency, with respect to the task execution amount and the power consumption of the physical server group 30 which are the metrics measurement values complemented by the metrics complementation unit 104.

Thus, the power efficiency calculation device 1 can determine whether or not the complementation between the metrics measurement values and correction (complementation) of the deviation between a time frame of power efficiency calculation and a metrics acquisition interval are required, and then calculate the integral value from the data of the complemented metrics measurement value to calculate accurate power efficiency.

A power efficiency calculation device according to the present invention is a power efficiency calculation device 1 for calculating power efficiency by executing an application 3 installed on a physical server group 30, the power efficiency calculation device 1 including: a metrics collection unit 101 configured to acquire a metrics measurement value from the physical server group 30, the metrics measurement value being an assessment index necessary for power efficiency calculation and including a task execution amount of the application and power consumption of the physical server group 30; a metrics measurement value complementation determination unit 102 configured to determine whether or not complementation between the metrics measurement values is required according to whether or not an amount of change in the metrics measurement value is equal to or more than a first prescribed value, and determine a predetermined complementation scheme according to whether or not the complementation is required; a metrics complementation unit 104 configured to perform the complementation between the metrics measurement values by using the predetermined complementation scheme determined by the metrics measurement value complementation determination unit 102; and a power efficiency calculation unit 105 configured to calculate an integral value in the time frame of the power efficiency calculation and calculate power efficiency, with respect to the task execution amount and the power consumption of the physical server group 30 which are the metrics measurement values complemented by the metrics complementation unit 104.

Thus, the power efficiency calculation device 1 can determine whether or not the complementation between the metrics measurement values is required, and then calculate the integral value from the data of the complemented metrics measurement value to calculate accurate power efficiency.

Further, in the power efficiency calculation device 1, the metrics measurement value complementation determination unit 102 determines the predetermined complementation scheme between the metrics measurement values to be linear complementation or polynomial complementation when the amount of change in the metrics measurement value is equal to or greater than the first prescribed value, and assumes that the interval between the metrics measurement values is a constant value and determines the predetermined complementation scheme between the metrics measurement values to be constant value complementation when the amount of change in the metrics measurement value is smaller than the first prescribed value.

Thus, the power efficiency calculation device 1 can execute appropriate complementation by using the linear complementation or polynomial complementation when a determination is made that complementation is required. On the other hand, the power efficiency calculation device 1 can reduce overhead due to unnecessary calculation by performing the constant value complementation when a determination is made that complementation is not required.

In the power efficiency calculation device 1, the metrics collection unit 101 collects the value of the wattmeter of the physical server group 30, and the metrics measurement value complementation determination unit 102 calculates an error based on the value of the wattmeter and a value obtained by performing linear complementation or polynomial complementation on power as a metrics measurement value, and sets the first prescribed value as a value decreasing as a difference between the calculated error and a preset error tolerance rate is smaller.

Thus, the power efficiency calculation device 1 can set an appropriate first prescribed value according to the amount of change in the metrics measurement value. Thus, the power efficiency calculation device 1 can appropriately determine whether or not the complementation between the metrics measurement values is required, and a complementation scheme thereof.

In the power efficiency calculation device 1, the metrics collection unit 101 acquires the value of the wattmeter of the physical server group 30 and power consumption that is the metrics measurement value for each predetermined period, and the metrics measurement value complementation determination unit 102 updates the first prescribed value by using the acquired value of the wattmeter and power consumption that is the metrics measurement value.

Thus, the first prescribed value is updated by using the value of the wattmeter and power consumption that is the metrics measurement value, which are acquired for each predetermined period, making it possible to perform the determination as to whether or not appropriate complementation is required according to the time change of the amount of change in the metrics measurement value, and the determination of complementation scheme.

A power efficiency calculation device according to the present invention is a power efficiency calculation device 1 for calculating power efficiency by executing an application 3 installed on a physical server group 30, the power efficiency calculation device 1 including: a metrics collection unit 101 configured to acquire a metrics measurement value from the physical server group 30, the metrics measurement value being an assessment index necessary for power efficiency calculation and including a task execution amount of the application 3 and power consumption of the physical server group; a power efficiency calculation frame complementation determination unit 103 configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and determine a predetermined complementation scheme according to whether or not the complementation is required; a metrics complementation unit 104 configured to perform complementation of the deviation between the time frame of power efficiency calculation and the metrics acquisition interval by using the predetermined complementation scheme determined by the power efficiency calculation frame complementation determination unit 103; and a power efficiency calculation unit 105 configured to calculate an integral value in the time frame of the power efficiency calculation and calculate power efficiency, with respect to the task execution amount and the power consumption of the physical server group 30 which are the metrics measurement values complemented by the metrics complementation unit 104.

Thus, the power efficiency calculation device 1 can determine whether or not correction (complementation) of the deviation between the time frame of power efficiency calculation and the metrics acquisition interval is required, and then calculate the integral value from the data of the complemented metrics measurement value to calculate accurate power efficiency.

Further, in the power efficiency calculation device 1, the power efficiency calculation frame complementation determination unit 103 determines the predetermined complementation scheme to be the linear complementation or polynomial complementation when the value of the deviation between the time frame of power efficiency calculation and the metrics acquisition interval is equal to or greater than the second prescribed value, and determines the predetermined complementation scheme for the deviation between the time frame of power efficiency calculation and the metrics acquisition interval to be the constant value complementation by regarding the metrics measurement value of the deviation between a time frame of power efficiency calculation and the metrics acquisition interval as a constant value when the value of the deviation between the time frame of power efficiency calculation and the metrics acquisition interval is smaller than the second prescribed value.

Thus, the power efficiency calculation device 1 can execute appropriate complementation by using the linear complementation or polynomial complementation when a determination is made that complementation is required. On the other hand, the power efficiency calculation device 1 can reduce overhead due to unnecessary calculation by performing the constant value complementation when a determination is made that complementation is not required.

The present invention is not limited to the embodiment described above, and various modifications can be made by a person of ordinary skill in the art within the technical idea of the present invention.

### REFERENCE SIGNS LIST

1: Power efficiency calculation device
3: Application (App)
10: Control unit
11 Input and output unit
12: Storage unit
30: Physical server group
100: Metrics collection DB
101: Metrics collection unit
102: Metrics measurement value complementation determination unit
103: Power efficiency calculation frame complementation determination unit
104: Metrics complementation unit
105: Power efficiency calculation unit
1000: Power efficiency calculation system

1. A power efficiency calculation device for calculating power efficiency by executing an application installed on a physical server group,
the power efficiency calculation device comprising:
a metrics collection unit configured to collect metrics measurement value from the physical server group, the metrics measurement value being an assessment index necessary for power efficiency calculation and including a task execution amount of the application and power consumption of the physical server group;
a metrics measurement value complementation determination unit configured to determine whether or not complementation between the metrics measurement values is required according to whether or not an amount of change in the metrics measurement value is equal to or more than a first prescribed value, and to determine a predetermined complementation scheme according to whether or not the complementation is required;
a power efficiency calculation frame complementation determination unit configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and to determine a predetermined complementation scheme according to whether or not the complementation is required;
a metrics complementation unit configured to perform the complementation between the metrics measurement values by using the predetermined complementation scheme determined by the metrics measurement value complementation determination unit, and to perform the complementation of the deviation between the time frame of power efficiency calculation and the metrics acquisition interval by using the predetermined complementation scheme determined by the power efficiency calculation frame complementation determination unit; and
a power efficiency calculation unit configured to calculate an integral value in the time frame of the power efficiency calculation and to calculate the power efficiency, with respect to the task execution amount and the power consumption of the physical server group which are the metrics measurement values complemented by the metrics complementation unit.

2. A power efficiency calculation device for calculating power efficiency by executing an application installed on a physical server group,
the power efficiency calculation device comprising:
a metrics collection unit configured to collect a metrics measurement value from the physical server group, the metrics measurement value being an assessment index necessary for power efficiency calculation and including a task execution amount of the application and power consumption of the physical server group;
a metrics measurement value complementation determination unit configured to determine whether or not complementation between the metrics measurement values is required according to whether or not an amount of change in the metrics measurement value is equal to or more than a first prescribed value, and to determine a predetermined complementation scheme according to whether or not the complementation is required;
a metrics complementation unit configured to perform the complementation between the metrics measurement values by using the predetermined complementation scheme determined by the metrics measurement value complementation determination unit; and
a power efficiency calculation unit configured to calculate an integral value in the time frame of the power efficiency calculation and to calculate power efficiency, with respect to the task execution amount and the power consumption of the physical server group which are the metrics measurement values complemented by the metrics complementation unit.

3. The power efficiency calculation device according to claim 1, wherein
the metrics measurement value complementation determination unit determines the predetermined complementation scheme between the metrics measurement values to be a linear complementation or a polynomial complementation when the amount of change in the metrics measurement value is equal to or greater than the first prescribed value, and assumes that a difference between the metrics measurement values is a constant value and determines the predetermined complementation scheme between the metrics measurement values to be a constant value complementation when the amount of change in the metrics measurement value is smaller than the first prescribed value.

4. The power efficiency calculation device according to claim 3, wherein
the metrics collection unit acquires a value of a wattmeter of the physical server group, and
the metrics measurement value complementation determination unit calculates an error based on the value of the wattmeter and a value obtained by performing the linear complementation or the polynomial complementation on power as a metrics measurement value, and sets the first prescribed value as a value decreasing as a difference between the calculated error and a preset error tolerance rate becomes smaller.

5. The power efficiency calculation device according to claim 4, wherein the metrics collection unit acquires the value of the wattmeter of the physical server group and a power consumption that is the metrics measurement value for each predetermined period, and
the metrics measurement value complementation determination unit updates the first prescribed value by using the acquired values of the wattmeter and the power consumption that is the metrics measurement value.

6. A power efficiency calculation device for calculating power efficiency by executing an application installed on a physical server group,
the power efficiency calculation device comprising:
a metrics collection unit configured to acquire a metrics measurement value from the physical server group, the metrics measurement value being an assessment index necessary for power efficiency calculation and including a task execution amount of the application and power consumption of the physical server group;
a power efficiency calculation frame complementation determination unit configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and to determine a predetermined complementation scheme according to whether or not the complementation is required;
a metrics complementation unit configured to perform the complementation of the deviation between the time frame of power efficiency calculation and the metrics acquisition interval by using the predetermined complementation scheme determined by the power efficiency calculation frame complementation determination unit; and
a power efficiency calculation unit configured to calculate an integral value in the time frame of the power efficiency calculation and to calculate power efficiency, with respect to the task execution amount and the power consumption of the physical server group which are the metrics measurement values complemented by the metrics complementation unit.

7. The power efficiency calculation device according to claim 1, wherein
the power efficiency calculation frame complementation determination unit determines the predetermined complementation scheme to be a linear complementation or a polynomial complementation when the value of the deviation between the time frame of power efficiency calculation and the metrics acquisition interval is equal to or greater than the second prescribed value, and determines the predetermined complementation scheme for the deviation between the time frame of power efficiency calculation and the metrics acquisition interval to be the constant value complementation by regarding the metrics measurement value of the deviation between a time frame of power efficiency calculation and the metrics acquisition interval as a constant value when the value of the deviation between the time frame of power efficiency calculation and the metrics acquisition interval is smaller than the second prescribed value.

8. A power efficiency calculation method for a power efficiency calculation device for calculating power efficiency by executing an application installed on a physical server group,
wherein the power efficiency calculation device executes:
a metrics collection step of collecting a metrics measurement value from the physical server group, the metrics measurement value being an assessment index necessary for power efficiency calculation and including a task execution amount of the application and power consumption of the physical server group;
a metrics measurement value complementation determination step of determining whether or not complementation between the metrics measurement values is required according to whether or not an amount of change in the metrics measurement value is equal to or more than a first prescribed value, and determining a predetermined complementation scheme according to whether or not the complementation is required;
a power efficiency calculation frame complementation determination step of determining whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and determining a predetermined complementation scheme according to whether or not the complementation is required;
a metrics complementation step of performing the complementation between the metrics measurement values by using the predetermined complementation scheme determined in the metrics measurement value complementation determination step, and performing complementation of the deviation between the time frame of power efficiency calculation and the metrics acquisition interval by using the predetermined complementation scheme determined in the power efficiency calculation frame complementation determination step; and
a power efficiency calculation step of calculating an integral value in a time frame of the power efficiency calculation and calculating power efficiency, with respect to the task execution amount and the power consumption of the physical server group which are the metrics measurement values complemented in the metrics complementation step.

9. A power efficiency calculation system comprising a physical server group on which an application in which one or more tasks are executed is installed; and a power efficiency calculation device for calculating power efficiency by executing the application installed on the physical server group,
wherein the power efficiency calculation device includes:
a metrics collection unit configured to collect a metrics measurement value from the physical server group, the metrics measurement value being an assessment index necessary for power efficiency calculation and including a task execution amount of the application and power consumption of the physical server group;
a metrics measurement value complementation determination unit configured to determine whether or not complementation between the metrics measurement values is required according to whether or not an amount of change in the metrics measurement values is equal to or more than a first prescribed value, and to determine a predetermined complementation scheme according to whether or not the complementation is required;
a power efficiency calculation frame complementation determination unit configured to determine whether or not complementation of a deviation between a time frame of power efficiency calculation and a metrics acquisition interval is required according to whether or not a value of the deviation between the time frame of power efficiency calculation and the metrics acquisition interval is equal to or more than a second prescribed value, and to determine a predetermined complementation scheme according to whether or not the complementation is required;
a metrics complementation unit configured to perform the complementation between the metrics measurement values by using the predetermined complementation scheme determined by the metrics measurement value complementation determination unit, and to perform the complementation of the deviation between the time frame of power efficiency calculation and the metrics acquisition interval by using the predetermined complementation scheme determined by the power efficiency calculation frame complementation determination unit; and
a power efficiency calculation unit configured to calculate an integral value in the time frame of the power efficiency calculation and to calculate power efficiency, with respect to the task execution amount and the power consumption of the physical server group which are the metrics measurement values complemented by the metrics complementation unit.

10. A non-transitory computer-readable storage medium storing a program for causing a computer to function as the power efficiency calculation device according to claim 1.
